(19) United States
(12) Patent Application Publication
(10) Pub. No.: US 2025/0347125 A1
(43) Pub. Date: Nov. 13, 2025

(54) DRAINAGE MESH

(71) Applicant: Innovative Construction Materials HK Ltd., Hong Kong (CN)

(72) Inventors: Wang Xiang Li, Haidian (CN); Brad Allshouse, Onsted, MI (US)

(21) Appl. No.: 18/928,282

(22) Filed: Oct. 28, 2024

(30) Foreign Application Priority Data
May 13, 2024 (CN) 202430279493.1

(51) Int. Cl. E04F 17/00; B29C 48/00; B29C 48/30; B29K 23/00; B29L 31/10

(52) U.S. Cl. CPC E04F 17/00; B29C 48/001; B29C 48/301; B29K 2023/00; B29L 2031/10

(57) ABSTRACT

The present disclosure provides a drainage mesh for use in an exterior wall system of a building. The drainage mesh can include a lattice structure and a plurality of protrusions. The lattice structure can include a plurality of intersecting strands. Each protrusion of the plurality of protrusions can extend substantially orthogonal from an intersection of the intersecting strands. A die head for forming the drainage mesh and a method of manufacturing the drainage mesh are also provided.

### CROSS-REFERENCE TO RELATED APPLICATIONS

This application claims the benefit of Chinese Patent Application No. 202430279493.1, filed on May 13, 2024. The entire disclosure of the above application is incorporated herein by reference.

### FIELD

The present technology relates to construction materials and methods, specifically to a drainage mesh for water management and airflow in exterior wall systems of buildings.

### INTRODUCTION

This section provides background information related to the present disclosure which is not necessarily prior art.

In the construction sector, effectively managing water within exterior wall systems is a challenge that impacts the durability and lifespan of buildings. Proper water management is important, particularly in environments prone to wind-driven rain, which can lead to extensive water ingress. Certain construction methods often fail to adequately address the complexities of moisture penetration and accumulation, highlighting the need for a more effective solution.

Certain water management strategies include the use of weather resistive barriers with integrated drainage features and the application of mechanical elements such as wood furring strips. These components aim to protect sensitive materials from direct water contact, aid in moisture expulsion, and promote airflow to remove moisture. Such approaches exhibit certain limitations, especially under conditions of heavy and continuous rainfall where their ability to manage water effectively is often insufficient. The shortcomings of certain solutions are apparent in their inadequate drainage capabilities and the potential for moisture entrapment. This can lead to accelerated deterioration of construction materials, particularly wood, which is susceptible to moisture damage. Consequently, the structural integrity of buildings can be jeopardized, increasing the need for maintenance intervention.

Accordingly, there is a need for a drainage mesh that enhances drainage and drying while being easily integrated into current building practices.

### SUMMARY

In concordance with the instant disclosure, a drainage mesh that enhances drainage and drying while being easily integrated into current building practices, has surprisingly been discovered. The present technology includes articles of manufacture, systems, and processes that relate to drainage mesh for exterior wall system and methods of manufacture and use.

In certain embodiments, a drainage mesh for use in an exterior wall system of a building is provided. The drainage mesh can include a lattice structure and a plurality of protrusions. The lattice structure can include a plurality of intersecting strands. Each protrusion of the plurality of protrusions can extend substantially orthogonally from an intersection of the intersecting strands.

In certain embodiments, a die head for use with an extrusion material in an extrusion process of a drainage mesh for building exterior wall systems is provided. The die head can include a first die body and a second die body. The first die body can include a first surface, a plurality of vertical channels and a horizontal channel. The plurality of vertical channels can be disposed on the first surface of the first die body and can be configured to form a plurality of vertical strands upon extruding the extrusion material. The horizontal channel can be disposed on the first surface of the first die body and can be configured to form a horizontal strand upon extruding the extrusion material. The horizontal channel can connect the plurality of vertical channels. The second die body can confront the first surface of the first die body and can be movable between an open position and a closed position. In the open position, the horizontal channel and a portion of each vertical channel can be exposed. The open position can allow the extrusion material to flow through the horizontal channel connecting the plurality of vertical channels and to flow outwards from the portion of each vertical channel. In the closed position, the second die body can cover the horizontal channel and a portion of each vertical channel. The first die body and the second die body can be configured to reciprocate with respect to each other between the open position to the closed position between the open position to the closed position to result in a protrusion of the extrusion material extending from each intersection of the vertical channels and the horizontal channel.

In certain embodiments, a method for extruding a drainage mesh for building exterior wall systems is provided. The method can include providing die head for an extrusion machine as described herein. The method can include a step of extruding the extrusion material through the die head and reciprocating the at least one of the second die body and the first die body between the open position and the closed position, whereby the drainage mesh is formed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a drainage mesh;

FIG. 2 is a side elevational view of the drainage mesh;

FIG. 3 is a front elevational of a lattice unit of the drainage mesh;

FIG. 4 is an environmental view of the drainage mesh installed in an exterior wall system of a building between a weather resistive barrier and exterior cladding;

FIG. 5 is a cross-sectional view of the drainage mesh installed in the exterior wall system;

FIG. 6 a schematic view of vertical channels and a horizontal channel of the die head depicting a flow of the extrusion material in the die head;

FIG. 7a is a top perspective view of a first die body and a second die body of the die head in the closed position;

FIG. 7b is a top perspective view of the first die body and the second die body in the open position;

FIG. 7c is a top perspective view of the first die body and the second die body in the open position with the extrusion material filing the vertical channels and the horizontal channel;

FIG. 7d is a top perspective view of a first die body and a second die body of the die head in the closed position with a lattice unit of the drainage mesh formed;

FIG. 8 is a top perspective view of the die body depicting the flow of extrusion material, according to one embodiment;

FIGS. 9A and 9B provide a flow diagram of a method of manufacturing the drainage mesh; and

FIG. 10 is a flow diagram of a method of installing the drainage mesh in an exterior wall system.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

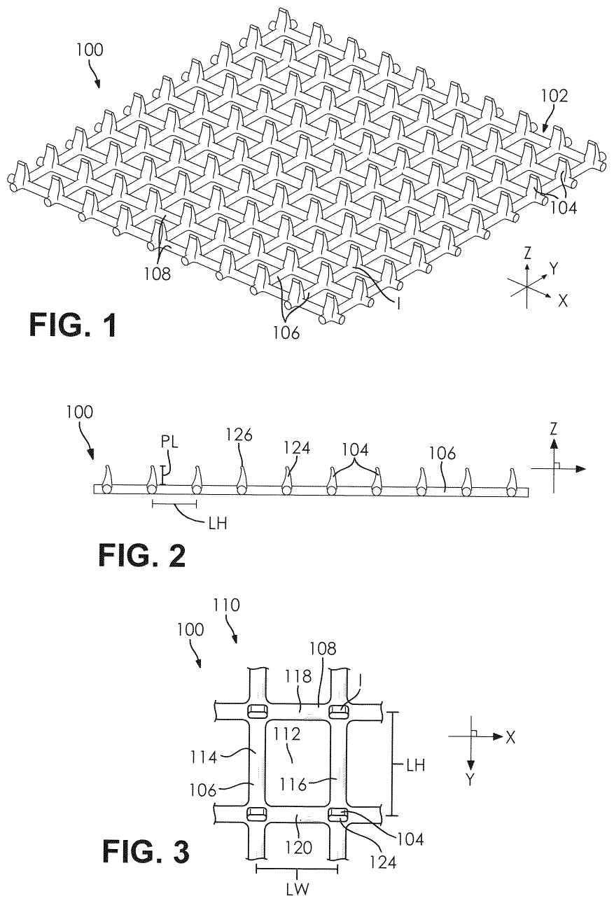

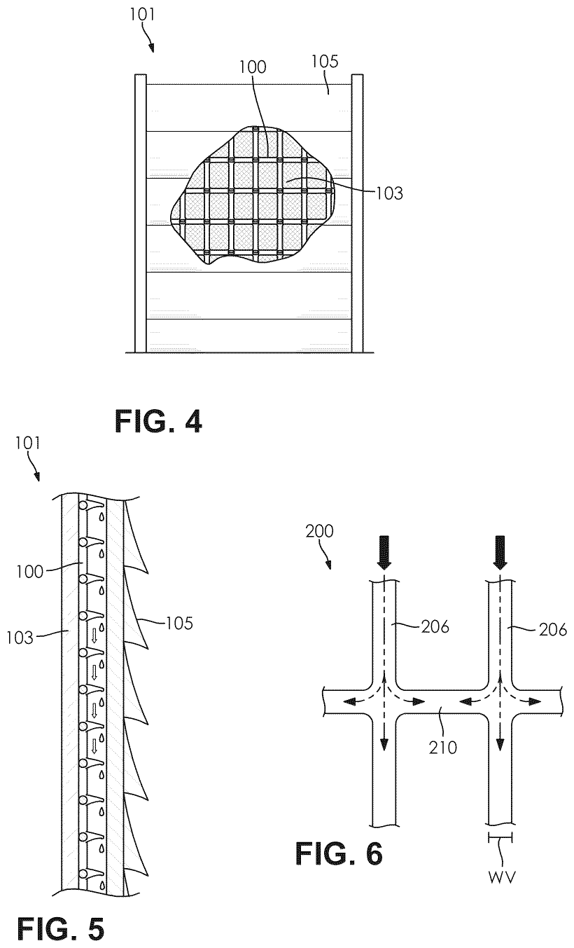

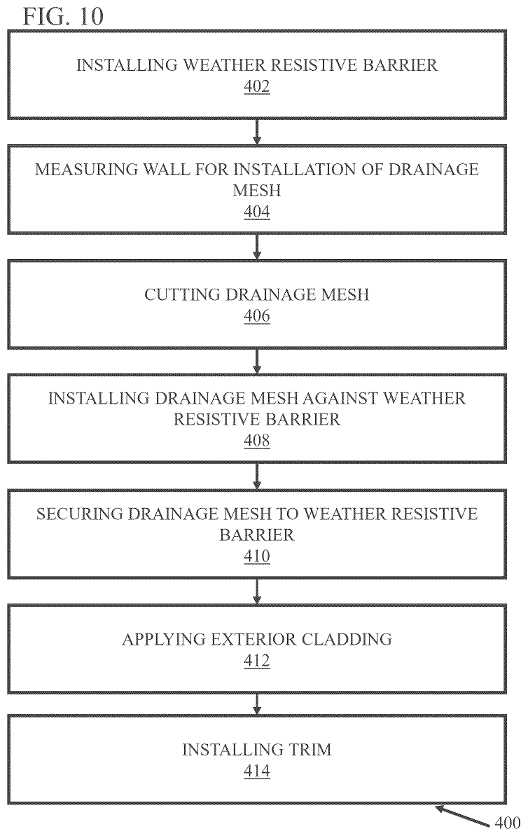

The present technology provides ways of making and using drainage mesh 100 having applications, for example, in building exterior wall systems. Examples of a mesh structure 100 and a method 300 for production are shown generally in FIGS. 1-10. The drainage mesh 100 can be installed in an exterior wall system 101 between a weather resistive barrier 103 and an exterior cladding 105, as shown in FIGS. 4-5. The drainage mesh 100 can be formed using a die head 200 in an extrusion process that allows control over the three-dimensional formation of the structure, including intersecting strands running in X & Y axes, respectively, and protrusions extending in a Z axis. Examples of a die head 200 and use thereof are shown generally in FIGS. 6-8. The method 300 of production facilitates consistent quality and efficiency in manufacturing, providing a solution for efficiently making a three-dimensional drainage mesh 100 suitable for building construction applications that benefit from reliable moisture evacuation and air circulation.

As shown in FIG. 1, the drainage mesh 100 can include a lattice structure 102 and multiple protrusions 104. The lattice structure 102 can include multiple intersecting strands including multiple vertical strands 106 and multiple horizontal strands 108. The intersection (I) of the vertical strands 106 and the horizontal strands 108, as shown in FIG. 3, can create the lattice structure 102. The vertical strands 106 can be disposed parallel with a Y-axis and the horizonal strands 108 can be disposed parallel with an X-axis. The four intersections (I) of two parallel vertical strands 106 and two parallel horizontal strands 108 can define a lattice unit 110 having a lattice opening 112. In certain embodiments, the vertical strands 106 and the horizontal strands 108 can intersect at substantially right angles in forming the lattice opening 112, as shown in FIG. 3. In some embodiments, the lattice opening 112 can take the shape of various quadrilaterals. For example, where the vertical strands 106 and horizontal strands 108 intersect at substantially right angles, the lattice opening 112 can be rectangular or square, depending upon the height of the vertical strands 106 and the width of the horizontal strands 108 of the lattice opening 112. In alternative embodiments, where the vertical strands 106 and the horizontal strands 108 intersect at non-right angles, the lattice opening 112 can take the shape of various parallelograms, such as a rhombus. A skilled artisan can select a suitable shape for the lattice opening within the scope of the present disclosure.

As shown in FIG. 3, each lattice unit 110 can have a lattice height (LH) defined by the height of the vertical stands 106 of the lattice unit 110 and a lattice width (LW) defined by the width of the horizontal strands 108 of the lattice unit 110. Where the lattice opening 112 is a parallelogram, the lattice height (LH) can be the same for both a first vertical strand 114 of the lattice unit 110 and a second vertical strand 116 of the lattice unit 110. Similarly, where the lattice opening 112 is a parallelogram, the lattice width (LW) can be the same for a top horizontal strand 118 and a bottom horizontal strand 120. Where the lattice opening 112 is substantially a square, the lattice height (LH) and the lattice width (LH) can be substantially the same. However, it should be appreciated that the lattice height (LH) and the lattice width (LW) can be different depending upon the varied heights of the vertical strands 106 and varied width of the horizontal strands 108.

With renewed reference to FIG. 1, the drainage mesh 100 can include multiple protrusions 104. Each protrusion 124 of the multiple protrusions 104 can be disposed substantially orthogonal from the intersection (I) of the intersecting vertical strands 106 and horizontal strands 108, such that the protrusion 104 is disposed along a Z-axis relative to the X-axis of the vertical strands 106 and the Y-axis of the horizonal strands 108. In this way, each corner of the lattice unit 110 can include a protrusion 104 extending in the Z-axis. Advantageously, when installed in a wall system 101, the protrusions 104 can maintain an airspace between the exterior cladding 105 and the weather resistive barrier 103, thereby allowing for excess liquid or vapor to move or fall down by gravity between the weather resistive barrier 103 and the exterior cladding 105. The protrusions 104, in combination with the lattice opening 112, create a breathable layer between the exterior cladding 105 and the weather resistive barrier 103, as shown in FIG. 5. In this way, the protrusion 104 and lattice structure 102 work together to militate against liquid or vapor becoming trapped between the weather resistive barrier 103 and the exterior cladding 105, which can result in warping, bubbling, or bowing of the exterior cladding 105.

The protrusions 104 can be substantially J-shaped such that a distal end 126 of the protrusion 104 curves, for example, like a talon, as shown in FIG. 2. The J-shape can be a result of the die head 200 and the manufacturing method 300, as described herein. Desirably, the J-shaped protrusion 104 can contribute to the effectiveness of the production in creating and maintaining airspace between the weather resistive barrier 103 and the exterior cladding 105. When the exterior cladding 105 is installed against the drainage mesh 100, the J-shaped nature of the protrusion 104 can allow for the protrusion 104 to angle downward slightly following the curve of the protrusion 104 instead of becoming compacted. By militating against the protrusion 104 compacting, the protrusion 104 can assist in maintaining a large enough gap and airspace for liquid to fall down between the weather resistive barrier 103 and the exterior cladding 105.

With reference to FIG. 2, the protrusion 104 can have a protrusion length (PL) along the z-axis. The protrusion length (PL) can be related to the lattice height (LH) as the protrusion 104 can be disposed along the vertical strand 106. In certain embodiments, the ratio of the protrusion length (PL) to the lattice height (LH) can range from about 1:4 to about 3:4. In a most particular example, the ratio of the protrusion length (PL) to the lattice unit height (LH) can be about 1:2. Advantageoulsy, the ratio creates an effective airspace between the exterior cladding 105 and the weather resistive barrier 103 by balancing drainage and drying capabilities, while also considering sufficient structural support and breathability. A skilled artisan can select a suitable protrusion length (PL) to lattice unit height (LH) ratio within the scope of the present disclosure.

It should be appreciated that the drainage mesh 100 can be formed from a variety of materials including polymers, for example. Polymers offer certain advantageous properties for the drainage mesh 100, such as durability, flexibility, and resistance to moisture and environmental factors, including temperature changes. In a certain embodiments, the drainage mesh 100 can include one or more polymers, such as various polyolefins including high-density polyethylene (HDPE), low-density polyethylene (LDPE), linear low-density polyethylene (LLDPE), ultra-high-molecular-weight polyethylene (UHMWPE), various copolymers of ethylene and propylene, and various combinations of such polymers. In certain embodiments, the drainage mesh 100 can be formed from a mixture of polyethylene and polypropylene. A skilled artisan can select a suitable material for forming the drainage mesh 100 within the scope of the present disclosure.

In certain embodiments, the drainage mesh 100 can include a polymer having a molecular weight ranging between about 100,000 g/mol and about 600,000 g/mol. Other examples include where the polymer can have a molecular weight ranging between about 200,000 g/mol and about 500,000 g/mol. Where the molecular weight of the polymer falls within these desired ranges, the viscosity and flow characteristics of the polymer for the extrusion process provided herein can be optimal. Further, polymers within the desired molecular weight range offer a balance of strength, flexibility, and durability desirable for the drainage mesh 100 in operation. A skilled artisan can select a suitable molecular weight for the polymer within the scope of the present disclosure.

In certain embodiments, the polymer can have a melting index range between about 0.25 g/10 min and about 1.25 g/10 min. Other examples include where the polymer can have a melting index range between about 0.5 g/10 min and about 1 g/10 min. Where the melting index of the polymer falls within these desired ranges, the viscosity and flow characteristics of the polymer for the extrusion process provided herein can be optimal. Further, polymers within the desired melting index range facilitate that the polymer remains stable at room temperature after extrusion and cooling, which allows the drainage mesh 100 to maintain its structure during manufacture and post-formation. A skilled artisan can select a suitable melting index range for the polymer within the scope of the present disclosure.

It should be appreciated that the drainage mesh 100 can utilize a polymer that is lightweight and less bulky in order to provide several advantages when used in exterior wall systems. The reduced weight and bulk can make the drainage mesh easier to handle, transport, and install. Additionally, the less bulky nature allows for streamlined integration into the wall assembly, militating against the overall thickness of the exterior wall while still maintaining moisture management capabilities.

In certain embodiments, the present disclosure can provide a die head 200 for use with an extrusion material in an extrusion process to manufacture the drainage mesh 100 for building exterior wall systems, as shown generally in FIGS. 6-8. The die head 200 can be fluidly coupled to an extruder (not shown) and can be used in the extrusion process. In operation, the extrusion material and any additives can be provided in the extruder where it is mixed and/or heated, and where the extrusion material can then be directed toward and pass through the die head 200. The extruder can impart various degrees of force to the extrusion material so that the extrusion material passes through the die head 200 at a predetermined rate. The force from the extruder can range from substantially the force of gravity on the extrusion material as it passes through the die head 200, to where the extruder includes a mechanical means (e.g., an auger) to direct the extrusion material through the die head 200 with a force greater than gravity. It should be understood that the extruder can mix one or more polymers, optionally heat the mixture, to where a suitable consistency is achieved, allowing the extrusion material to pass from the extruder to the die head 200 substantially by the force of gravity. The extrusion process and die head 200 provided herein can be contrasted with typical plastic extrusion applications used in forming plastic sheeting, tubing, and the like, where pressures of 5,000 psi or more can be required to force plastic through a die head in such applications.

The drainage mesh 100 can be formed from an extrusion material that is prepared to have a dough-like consistency. The extrusion material can include one or more polymers that are selected having melting index ranges, as described herein, where the polymers are blended, mixed with additives, and optionally heated, such that the resulting extrusion material can have a viscosity that allows gravity-based flow of the extrusion material. Embodiments include where the extrusion material can be directed toward the die head 200 using mechanical assistance (e.g., use of an auger, mixing means, or other conveyance), but where the extrusion material can conform as directed by the die head 200. Resulting extrusion pressure through the die head 200 can include pressures resulting only from gravity up to 1400 psi. Embodiments include extrusion pressures through the die head 200 ranging from 700-1400 psi, 800-1300 psi, and about 1000 psi.

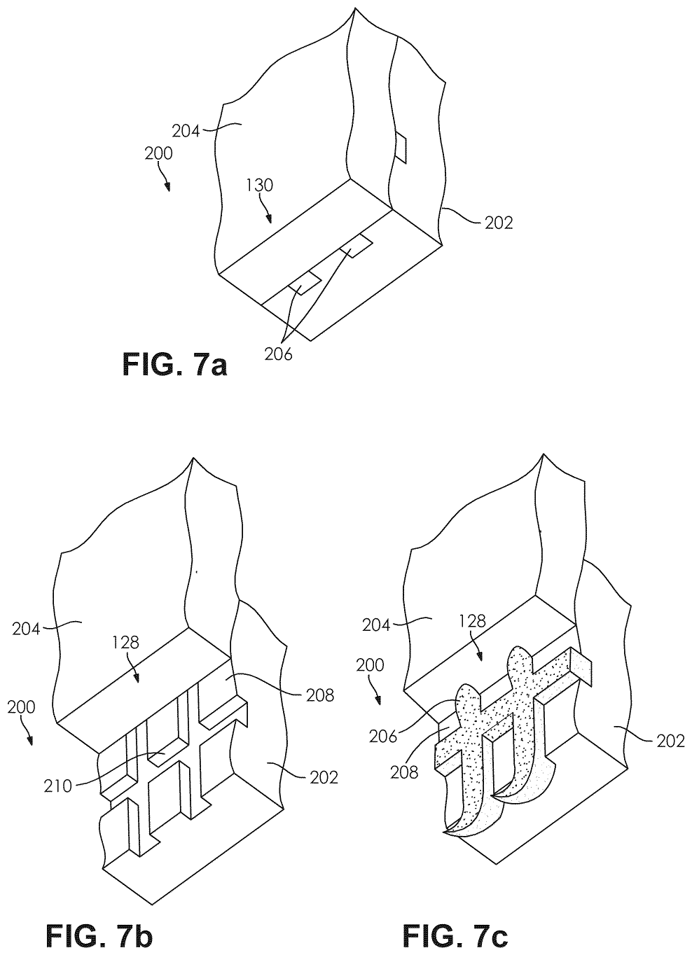

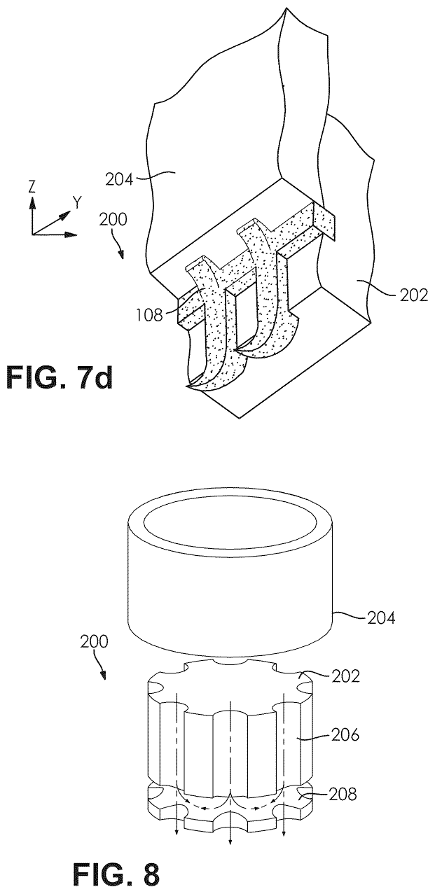

As shown in FIG. 7a-7d, the die head 200 can include a first die body 202 and a second die body 204. The first die body 202 and the second die body 204 can be any shape that allows for flow of the extrusion material through the die head 200 to create the drainage mesh 100. In a particular example shown in FIG. 8, first die body 202 can be substantially cylindrical and the second die body 204 can be a cylindrical collar disposed around the first die body 202. In an alternative embodiment, the first die body 202 can be substantially cuboid, and the second die body 204 can be substantially cuboid and disposed on one face of the first die body 202. A skilled artisan can select a suitable shape for the first die body 202 and the second die body 204 within the scope of the present disclosure.

With reference to FIG. 8, the first die body 202 can include multiple vertical channels 206 disposed on a first surface 208 of the first die body 202. The vertical channels 206 can be configured to form the vertical strands of the drainage mesh 100 upon extruding the extrusion material. It should be appreciated that the vertical channels 206 can be configured to allow continuous flow of the extrusion material regardless of the position of the second die body 204. The continuous flow of the extrusion material through the vertical channels 206 of the die head 200 allows for the lattice structure of the drainage mesh 100 to be formed. The continuous flow of the extrusion material through the vertical channels 206 facilitates formation of the vertical strands without interruption, maintaining the structural integrity of the lattice. Although FIGS. 7a-7d show two vertical channels 206 in order to form a lattice unit, the first die body 202 can include additional vertical channels 206 to form adjacent lattice units. Likewise, although FIG. 8 shows eight vertical channels about the cylindrical first die body 202, the first die body 202 can be sized and configured to include additional vertical channels 206 to increase a number of adjacent lattice units.

With reference to FIG. 6, the width (WV) of the vertical channels 206 can be altered to change the width of the resulting vertical strands. Customization of the width of the vertical channels 206 allows for customization of the mesh structure to suit different application requirements for different building environments. A length of the vertical channels 206 can also be tailored to adjust the resulting lattice unit dimensions.

With reference to FIGS. 7a-7d, the first die body 202 can include a horizontal channel 210, which can be disposed on the first surface 208. The horizontal channel 210 can connect the plurality of vertical channels 206. The horizontal channel 210 can be configured to form a horizontal strand upon extruding the extrusion material. Unlike the vertical channels 206 that allow continuous flow of the extrusion material, the horizontal channel 210 operates intermittently, controlled by the movement of the second die body 204. The continuous flow through the vertical channels 206, combined with the intermittent flow through the horizontal channel 210 controlled by the second die body 204, enables the formation of the lattice structure 102 of the drainage mesh 100, including the protrusions 104 at the intersections (I) of the vertical strands 106 and the horizontal strands 108. The extrusion material can begin to exit or overflow the horizontal channel 210 and the vertical channels 206 when the second die body 204 moves to an open position 128 (FIG. 7c). The protrusions 104 can be formed when the second die body 204 moves between the open position 128 (FIG. 7c) and a closed position 130 (FIG. 7a), allowing the portion of the exiting or overflowing extrusion material to be pushed upwards and outwards, forming the horizontal strand 108 of the lattice unit and forming the protrusions 104 at the intersections (I) of the vertical and horizontal strands of the lattice units.

As shown in FIGS. 7a-7d, the die head 200 can include the second die body 204. The second die body 204 can confront the first surface 208 of the first die body 202. At least one of the first die body 202 and the second die body 204 can be movable between the open position 128 and the closed position 130. The open position 128 can allow the extrusion material to flow through the horizontal channel 210 connecting the plurality of vertical channels 206 and to flow outwards from the portion of each vertical channel 206. In the closed position 130, the second die body 204 can cover the horizontal channel 210 and a portion of each vertical channel 206. The first die body 202 and the second die body 204 can be configured to reciprocate with respect to each other between the open position 128 to the closed position 130 to result in the protrusion 104 of the extrusion material extending from each intersection (I) of the vertical channels 206 and the horizontal channel 210. It should be appreciated that the first die body 202 can be configured to reciprocate with respect to the second die body 204, the second die body 204 can be configured to reciprocate with respect to the first die body 202, or the first die body 202 and the second die body 204 can be configured to reciprocate with respect to each other. Where in the open position 128, the horizontal channel 210 can be exposed, and the extrusion material can flow outwards from the vertical channels 206 into the horizontal channel 210. The flow of extrusion material through the horizontal channel 210 forms a single horizontal strand 108 of the lattice structure. In the closed position 130 extrusion material cannot flow outward of the vertical channels 206 and the horizontal channel 210 and only a vertical strand 106 is formed.

The process of creating the horizontal strands 108 one at a time is tied to the movement of the second die body 204. With reference to FIGS. 7a-7d, as the second die body 204 can move from the closed position 130 to the open position 128, the second die body 204 exposes the horizontal channel 210, allowing the extrusion material to flow outwards and form the horizontal strand 108. When the second die body 204 moves back to the closed position 130, the second die body 204 cuts off the flow of extrusion material through the horizontal channel 210, effectively ending the formation of that particular horizontal strand 108.

The intermittent flow, controlled by the movement of the second die body 204, creates the horizontal strands 108 of the lattice structure 102 one at a time. A reciprocation time of the movement of the second die body 204 can correspond to the lattice unit height (LH). The reciprocation time of the movement between the open position 128 and the closed position 130 ensures that the horizontal strands are formed at regular intervals of lattice unit height (LH) creating the uniform lattice structure 102 of the drainage mesh 100. Moreover, the movement of the second die body 204 between the open position 128 and closed positions 130 not only controls the formation of horizontal strands 108 and the lattice unit height (LH) but also creates the protrusions 104 at the intersections (I) of the vertical strands 106 and horizontal strands 108. Where the second die body 204 is in the open position 128, the extrusion material can flow from the vertical channels 206 along the X-axis to the horizontal channel 210 and also outward along the Z-axis to form the protrusion 104. The movement of the second die body 204 from the open position 128 to the closed position 130 can push the extrusion material outwards and pinch off the protrusion 104, creating the J-shape protrusion discussed herein.

It should also be noted that the second die body 204 can move between the open position 128 and the closed position 130 defined by a reciprocation distance. The reciprocation distance can correspond to the length (PL) of the protrusion 104 as the protrusion extends from the intersection (I) of the vertical channels 206 and the horizontal channel 210.

It should be appreciated that the reciprocation time of the movement of the second die body 204 between the open position 128 and the closed position 130 can alter certain dimensions of the drainage mesh 100, including the lattice unit height (LH) and the protrusion length (PL), as shown in FIGS. 1-3. For example, where the second die body 204 is paused in the closed position 130, the lattice unit height (LH) will increase because the extrusion machine will continue to form the vertical strands 106 but formation of the horizontal strand 108 will be stopped, increasing the lattice unit height (LH). Alternatively, where the second die body 204 is paused in the open position 128, a horizontal strand height (HH), defined as the height of a horizontal strand 108, along with the protrusion length (PL) will increase because the extrusion material is free to flow in the horizontal channel 210 (X-axis direction) and the Z-axis, creating the protrusion 104, for a longer duration of time and allowing more extrusion material to be pushed by the second die body 204 in moving to the closed position 130.

In operation, the extrusion material can enter the die head 200. The extrusion material can continuously flow through the vertical channels 206, as depicted in FIG. 8 with arrows. Where the second die body 204 is in the open position 128, the extrusion material can flow into the horizontal channel 210 and out along the Z-axis to form the protrusions 104, as shown in FIGS. 7c and 7d. As the second die body 204 moves into the closed position 130, the vertical strands are continuously made but the horizontal channel 210 is closed off blocking the extrusion material from entering the horizontal channel 210, as shown in FIG. 7a. At the same time, the second die body 204 pinches off the extrusion material to form the horizontal strand 108 and the protrusion 104. With two reciprocal movements of the second die body 204, the lattice structure 102 is formed including the lattice opening 112 and protrusions at each intersection (I) of the lattice structure 102. As the reciprocal movement of the second die body 204 repeats, the lattice structure 102 grows in length to produce the drainage mesh 100.

In operation, the flow of the extrusion material can be controlled and distributed evenly to promote uniform thickness and consistency of the drainage mesh 100. The temperature of the die head 200 can be regulated to maintain a predetermined viscosity of the extrusion material as it passes through the die head 200 to form the drainage mesh 100. A skilled artisan can select a suitable temperature for the extrusion material within the scope of the present disclosure. In general, the die head 200 can be made from durable, heat-resistant metals such as tool steel or stainless steel. A skilled artisan can select a suitable material for the die head 200 within the scope of the present disclosure.

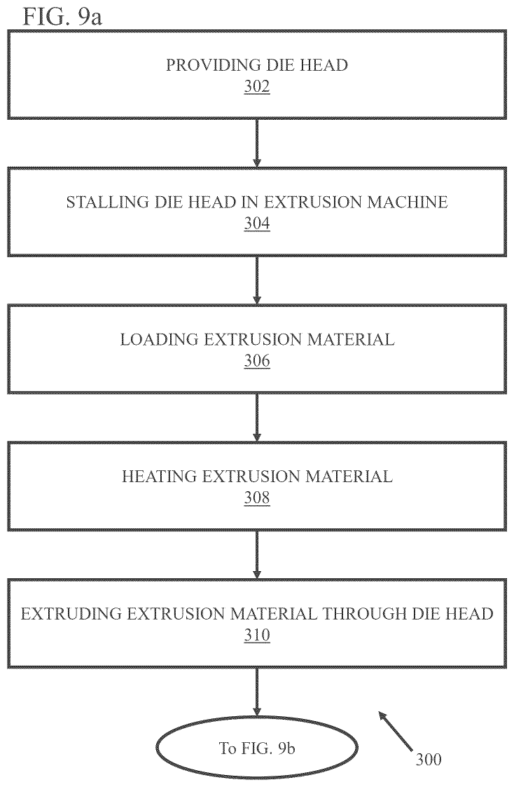

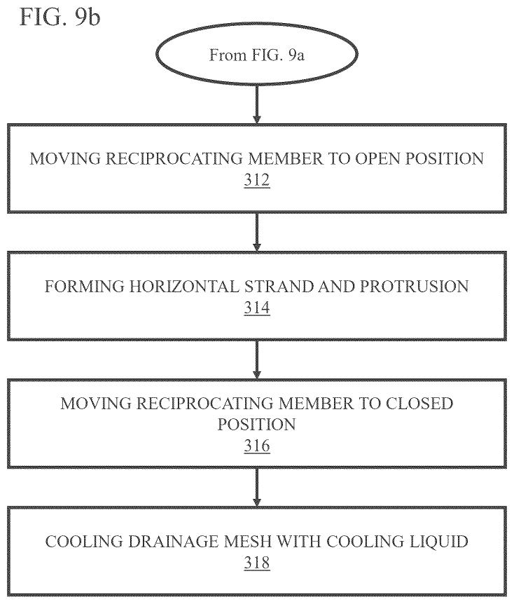

In certain embodiments, the present disclosure provides a method 300 for extruding the drainage mesh 100 for an exterior wall system 101, shown generally in FIGS. 7a-7d and 9a-9b. The method 300 can include a step 302 of providing a die head 200, as described herein, for an extrusion machine. In a step 304, the method 300 can include installing the die head 200 into the extrusion machine and a step 306 of loading the extrusion material into the extrusion machine. As described herein, the extrusion material can be a polymer specific for forming the drainage mesh 100.

The method 300 can include heating the extrusion material to a predetermined temperature in a step 308. The extrusion material can be heated to a temperature to allow for the extrusion material to flow through the die head 200 for extrusion. For example, the extrusion material can be heated to a temperature between about 100° C. and about 280° C. A skilled artisan can select a suitable temperature for the extrusion material during extrusion as desired.

In a step 310, the method 300 can include extruding the extrusion material through the die head 200, wherein the extrusion material flows through the vertical channels 206 continuously forming vertical strands 106 of the drainage mesh 100. In certain embodiments, the extrusion material can be extruded through the die head at a rate substantially determined by gravity such that the extrusion material is not being pushed through the die head 200. In certain embodiments, the weight of the lattice structure 102 of the previously formed drainage mesh 100 along with gravity can be the only force pulling the extrusion material through the die head 200 to form the drainage mesh 100. Alternatively, the extrusion material can be pulled or pushed through the die head 200 at a predetermined rate. As a non-limiting example, the predetermined rate can be between about 10 meters per minute and about 20 meters per minute. A skilled artisan can select a suitable predetermined rate as desired.

The second die body 204 can be moved to the open position 128 to allow the extrusion material to flow into the horizontal channel 210 and outward to create the protrusions 104 in a step 312, as shown in FIGS. 7c and 7d. The method 300 can include a step 314 of forming a horizontal strand 108 and a protrusion 104 of the drainage mesh 100 simultaneously. The second die body 204 can be moved to the closed position 130 to restrict flow of the extrusion material to the horizontal channel 210 allowing only vertical extrusion in a step 316 of the method 300, as shown in FIG. 7a.

In a step 318, the extruded drainage mesh 100 can be cooled in a cooling liquid to solidify the drainage mesh in a desired shape, as described herein. In a non-limiting example, the cooling liquid can include water. Additionally, the cooling liquid can be set to a predetermined temperature to efficiently cool the drainage mesh 100. For example, the cooling liquid can be set to a predetermined temperature between about 5° C. and about 20° C., as desired. In operation, the drainage mesh 100 can remain in the cooling liquid for a predetermined cooling time. As an example the drainage mesh 100 the predetermined cooling time can be between about 30 seconds to about 1 minute. A skilled artisan can select a suitable cooling liquid, predetermined temperature, and predetermined cooling time within the scope of the present disclosure.

With reference to FIGS. 4-5 and 11, the present disclosure can further provide a method 400 of installing the drainage mesh 100 in an exterior wall system 101 of a building. The method 400 can include a step 402 of installing the weather resistive barrier 103 on a wall of the exterior wall system 101. In a step 404, the wall can be measured for installation of the drainage mesh 100 and in a step 406, the drainage mesh can be cut based on the measurements collected. The drainage mesh 100 can be installed against the weather resistive barrier 103 such that the protrusions 104 are facing outward, away from the weather resistive barrier 103 in a step 408. The method 400 can include a step 410 of is securing the drainage mesh 100 to the weather resistive barrier 103 using a fastening means such as cap nails or staples, for example. In a step 412, exterior cladding 105 can be applied over the drainage mesh 100. The method 400 can include a step 414 of installing any necessary trim pieces and sealing around penetrations and openings as required. The method 400 utilizes the lightweight and less bulky features of the drainage mesh 100, making it easier to handle and install compared to traditional methods like wood furring strips.

Desirably, the drainage mesh 100 offers several advantages in an exterior wall system 101. The lattice structure 102 with strategically placed protrusions 104 creates an effective airspace between the exterior cladding 105 and the weather resistive barrier 103, enhancing drainage and promoting drying within wall systems. The lightweight and less bulky polymer composition of the drainage mesh 100 makes it easier to handle, transport, and install, potentially saving time and labor costs during construction. Additionally, the die head 200 of the present disclosure provides advantages in the manufacturing process. The structure of the die head 200 including vertical channels 206 for continuous extrusion and the horizontal channel 210 controlled by the second die body 204, allows for precise formation of the lattice structure 102 and protrusions 104. Further, the ability to alter the width of the vertical channels 206 enables customization of the structure of the drainage mesh 100 to suit different application requirements. The flexibility of the structure contributes to the efficiency of the die head 200 in producing a drainage mesh 100 optimized for various building environments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A drainage mesh for use in an exterior wall system of a building, comprising:
a lattice structure including a plurality of intersecting strands; and
a plurality of protrusions, each protrusion extending substantially orthogonal from an intersection of the intersecting strands.

2. The drainage mesh of claim 1, wherein the lattice structure includes a polymer.

3. The drainage mesh of claim 2, wherein the polymer includes a polyolefin.

4. The drainage mesh of claim 3, wherein the polyolefin includes a member selected from a group consisting of polyethylene, polypropylene, and combinations thereof.

5. The drainage mesh of claim 2, wherein the polymer has a molecular weight between about 200,000 g/mol and about 500,000 g/mol.

6. The drainage mesh of claim 2, wherein the polymer includes a melting index range between about 0.5 g/10 min and about 1 g/10 min.

7. The drainage mesh of claim 1, wherein each protrusion includes a talon shape.

8. A building exterior wall system, comprising:
a weather resistive barrier;
a cladding; and
a drainage mesh according to claim 1, wherein the drainage mesh is disposed between the weather resistive barrier and the cladding.

9. A die head for use with an extrusion material in an extrusion process, comprising:
a first die body including
a first surface,
a plurality of vertical channels disposed on the first surface, the plurality of vertical channels configured to form a plurality of vertical strands upon extruding the extrusion material therethrough, and
a horizontal channel disposed on the first surface, the horizontal channel configured to form a horizontal strand upon extruding the extrusion material therethrough, the horizontal channel forming intersections with and connecting the plurality of vertical channels; and
a second die body confronting the first surface of the first die body, one of the first die body and the second die body movable between an open position and a closed position,
wherein
the open position exposes the horizontal channel and a portion of each vertical channel, the open position allowing the extrusion material to flow through the horizontal channel connecting the plurality of vertical channels and to flow outwards from the portion of each vertical channel,
the closed position covers the horizontal channel and the portion of each vertical channel, and
wherein one of the first die body and the second body is configured to reciprocate with respect to the other of the first die body and the second die body between the open position to the closed position to result in a protrusion of the extrusion material extending from each intersection of the horizontal channel and the vertical channels.

10. The die head of claim 9, wherein the plurality of vertical channels is configured to allow continuous flow of the extrusion material therethrough when the second die body is the open position and in the closed position.

11. The die head of claim 9, wherein the first surface of the first die body includes a substantially cylindrical portion.

12. The die head of claim 11, wherein the second die body includes a collar portion disposed around the substantially cylindrical portion.

13. The die head of claim 9, wherein the second die body moves a predetermined distance between the open position and the closed position, the predetermined distance corresponding to a height of the protrusion extending from each intersection of the vertical channels and the horizontal channel.

14. The die head of claim 9, wherein the second die body moves at a predetermined time between the open position and the closed position, the predetermined time corresponding to a lattice unit height and a protrusion height.

15. A method for extruding a drainage mesh of extrusion material for building exterior wall systems, comprising:
providing a die head according to claim 9;
extruding the extrusion material through the die head; and
reciprocating one of the first die body and the second body with respect to the other of the first die body and the second die body between the open position to the closed position to result in the protrusion of the extrusion material extending from each intersection of the horizontal channel and the vertical channels.

16. The method of claim 15, wherein the extrusion material is extruded through the die head at a rate substantially determined by gravity.

17. The method of claim 15, further comprising pulling the extrusion material through the die head.

18. The method of claim 15, wherein the extrusion material is pulled through the die head at a rate between 10 meters per minute and 20 meters per minute.

19. The method of claim 15, further comprising cooling the drainage mesh.

20. A drainage mesh produced according to the method of claim 15.
